(19) United States
(12) Patent Application Publication
(10) Pub. No.: US 2008/0267295 A1
(43) Pub. Date: Oct. 30, 2008

(54) Video decompression, de-interlacing and frame rate conversion with frame buffer compression

(76) Inventor: Chih-Ta Star Sung, Glonn (DE)

Correspondence Address: Chih-Ta Star Sung, Rm. 308, Bld. 52, No. 195, Sec. 4, Chung Hsin Rd., Juhdong, 310, TW

(21) Appl. No.: 11/789,795

(22) Filed: Apr. 26, 2007

(51) Int. Cl. H04N 7/12

(52) U.S. Cl. 375/240.24; 375/E07.026

(57) ABSTRACT

Inter-frame and intra-frame block pixel compression means are applied to re-compress the decompressed video field/frame for future digital video decompression, de-interlacing and frame conversion. The motion vectors, MVs, decompressed from the compressed video field/frame are temporarily saved in a buffer for future inter-frame coding of block by block re-compression. If the input video frames are uncompressed or decompressed fields/frames, they will be compressed before saving into an off-chip frame buffer, later, the accessed lines of compressed pixels of at least two fields/frames will be used for de-interlacing and frame rate conversion. If the corresponding MV is out of the predetermined threshold, inter-frame coding will be skipped and only intra-frame coding is applied.

### BACKGROUND OF THE INVENTION

1. Field of Invention

The present invention relates to digital video decompression, de-interlacing and frame rate conversion with referencing frame buffer compression. And, more specifically to an efficient image buffer compression for video stream decompression, de-interlacing method and image interpolation which sharply reduces the IO bandwidth requirement of the off-chip frame buffer or reduces the dies area of on-chip line buffer.

2. Description of Related Art

ISO and ITU have separately or jointly developed and defined some digital video compression standards including MPEG-1, MPEG-2, MPEG4, MPEG-7, H.261, H.263 and H.264. The success of development of the video compression standards fuels wide applications which include video telephony, surveillance system, DVD, and digital TV. The advantage of digital image and video compression techniques significantly saves the storage space and transmission time without sacrificing much of the image quality.

Most ISO and ITU motion video compression standards adopt Y, U/Cb and V/Cr as the pixel elements, which are derived from the original R (Red), G (Green), and B (Blue) color components. The Y stands for the degree of “Luminance”, while the Cb and Cr represent the color difference been separated from the “Luminance”. In both still and motion picture compression algorithms, the 8×8 pixels “Block” based Y, Cb and Cr goes through the similar compression procedure individually.

There are essentially three types of picture encoding in the MPEG video compression standard. I-frame, the “Intra-coded” picture uses the block of 8×8 pixels within the frame to code itself. P-frame, the “Predictive” frame uses previous I-type or P-type frame as a reference to code the difference. B-frame, the “Bi-directional” interpolated frame uses previous I-frame or P-frame as well as the next I-frame or P-frame as references to code the pixel information. In principle, in the I-frame encoding, all “Block” with 8×8 pixels go through the same compression procedure that is similar to JPEG, the still image compression algorithm including the DCT, quantization and a VLC, the variable length encoding. While, the P-frame and B-frame have to code the difference between a target frame and the reference frames.

In compressing or decompressing the P-type or B-type of video frame or block of pixels, the referencing memory dominates high semiconductor die area and cost. If the referencing frame is stored in an off-chip memory, due to I/O data pad limitation of most semiconductor memories, accessing the memory and transferring the pixels stored in the memory becomes bottleneck of most implementations. One prior method overcoming the I/O bandwidth problem is to use multiple chips of memory to store the referencing frame which cost linearly goes higher with the amount of memory chip. Some times, higher speed clock rate of data transfer solves the bottleneck of the I/O bandwidth at the cost of higher since the memory with higher accessing speed charges more and more EMI problems in system board design. In MPEG2 TV application, a Frame of video is divided to be “odd field” and “even field” with each field being compressed separately which causes discrepancy and quality degradation in image when 2 fields are combined into a frame before display.

De-interlacing is a method applied to overcome the image quality degradation before display. For efficiency and performance, 3-4 of previous frames and future frames of image are used to be reference for compensating the potential image error caused by separate quantization. De-interlacing requires high memory I/O bandwidth since it accesses 3-5 frames.

In some display applications, frame rate or field rate need to be converted to fit the requirement of higher quality and the frame rate conversion is needed which requires referring to multiple frames of image to interpolate extra frames which consumes high bandwidth of memory bus as well.

The method of this invention of video de-interlacing and frame rate conversion coupled with video decompression applies referencing frame compression mechanisms which significantly reduces the requirement of memory IO bandwidth and costs less storage device.

### SUMMARY OF THE INVENTION

The present invention is related to a method of digital video de-interlacing and frame rate conversion with the referencing frame buffer compression and decompression which reduces the semiconductor die area/cost sharply since the referencing frame buffer dominate the die area in an SoC design. This method also reduces the memory density and I/O bandwidth requirement sharply if off-chip memory is applied to store the compressed referencing frame. The present invention reduces semiconductor die area compared to its counterparts in the field of image frame compression and decompression and reaches good image quality.
The present invention of this efficient digital video de-interlacing and frame rate conversion compresses and reduces the data rate of the digital video frames which are used as reference for video de-interlacing.
According to one embodiment of the present invention, each block of Y, luminance and UN, chrominance of the referencing frame are compressed before storing to the referencing frame buffer and decompressed before feeding to the line buffer for de-interlacing and frame rate conversion.
According to one embodiment of the present invention, variable bit rate of each block of the Y and UN components is reached for the pixels within a referencing image frame and come out of a fixed bit rate of a whole referencing frame.
According to one embodiment of the present invention, a predetermined time is set to reconstruct a slice of blocks of Y and UN pixel components video de-interlacing and frame rate conversion.
According to one embodiment of the present invention, at least two lines of pixel buffer is designed to temporarily store a decompressed blocks of Y and Cr/Cb pixel components for video de-interlacing.
According to one embodiment of the present invention, at least two video decoding engines are running in parallel to reconstruct at least two frames/fields at a time and the already reconstructed at least two frames/fields together with the at least two under reconstruction can be used to de-interlacing and interpolating to form new frame.
According to one embodiment of the present invention, if the input video is in a compressed format, both inter-frame and intra-frame block based coding are run in parallel and compared, the one with less bit rate is selected to be the compression mode.
According to one embodiment of the present invention, the motion vectors (MVs) embedded in the video stream can be decoded and saved into a temporary buffer and be used in the P-type like frame buffer inter-frame compression.
According to an embodiment of the present invention, during random accessing any area, the starting location of the selected area within storage device is calculated firstly, and then, the pixels are decompressed in pipelining.
According to another embodiment of the present invention, the temporary buffer saves the address of starting address of each line of a predetermined amount of lines of pixels and being sent to the memory accompanied with a control signal to indicate the type of transferring data.
According to another embodiment of the present invention, if the input video is in an uncompressed or decompressed image, the image will be compressed before storing into the off-chip memory, and later, the accessed pixels from variable compressed frames are used in calculation of video de-interlacing as well as interpolating addition video frame between the accessed frames.
According to another embodiment of the present invention, the line by line pixels formed by de-interlacing and by interpolating to form new video frame are separately writing into the frame buffer memory.
According to one embodiment of the present invention, the recompressed lines of multiple frames are used to de-interlacing and frame rate conversion by applying interpolation means when the video decoding is in process.
According to one embodiment of the present invention, if the input video is in a compressed format, multiple video decoding engines are running in parallel to reconstruct at least two fields/frames at a time and the already reconstructed two referencing frames/fields together with the two under reconstruction can be used to de-interlacing and interpolating to form new frame.
According to one embodiment of the present invention, a predetermined time is set to reconstruct a slice of blocks of Y and UN pixel components video de-interlacing and frame rate conversion by interpolation means.
According to another embodiment of the present invention, the line by line pixels constructed by de-interlacing and by interpolating to form new video frame are separately writing into the frame buffer memory.

It is to be understood that both the foregoing general description and the following detailed description are by examples, and are intended to provide further explanation of the invention as claimed.

### BRIEF DESCRIPTION OF THE DRAWINGS

FIG. 1 shows the basic three types of motion video coding.

FIG. 2 depicts a block diagram of a video compression procedure with two referencing frames saved in so named referencing frame buffer.

FIG. 3 illustrates the block diagram of video decompression.

FIG. 4 illustrates Video compression with interlacing mode.

FIG. 5 depicts a prior art video decompression and de-interlacing.

FIG. 6 depicts basic concept of frame rate conversion.

FIG. 7 depicts a prior art video decompression, de-interlacing and frame rate conversion.

FIG. 8 depicts present invention of video decompression, de-interlacing and frame rate conversion.

FIG. 9 illustrates the present invention of the mechanism of parallel decoding multiple frames, de-interlacing and interpolating new frame by using the same decompressed rows of macro-block pixels and the rows of macro-block of referencing fields/frames.

FIG. 10 illustrates a means of inter-frame compression and intra-frame compression.

FIG. 11 illustrates the means of re-compressing the decompressed rows of macro-block pixels to reduce the data rate in the temporary buffer.

FIG. 12 illustrates de-interlacing and frame rate conversion of uncompressed or decompressed video fields/frame.

### DESCRIPTION OF THE PREFERRED EMBODIMENTS

There are essentially three types of picture coding in the MPEG video compression standard as shown in FIG. 1. I-frame 11, the “Intra-coded” picture, uses the block of pixels within the frame to code itself. P-frame 12, the “Predictive” frame, uses previous I-frame or P-frame as a reference to code the differences between frames. B-frame 13, the “Bi-directional” interpolated frame, uses previous I-frame or P-frame 12 as well as the next I-frame or P-frame 14 as references to code the pixel information.

In most applications, since the I-frame does not use any other frame as reference and hence no need of the motion estimation, the image quality is the best of the three types of pictures, and requires least computing power in encoding since no need for motion estimation. The encoding procedure of the I-frame is similar to that of the JPEG picture. Because of the motion estimation needs to be done in referring both previous and/or next frames, encoding B-type frame consumes most computing power compared to I-frame and P-frame. The lower bit rate of B-frame compared to P-frame and I-frame is contributed by the factors including: the averaging block displacement of a B-frame to either previous or next frame is less than that of the P-frame and the quantization step is larger than that in a P-frame. In most video compression standard including MPEG, a B-type frame is not allowed for reference by other frame of picture, so, error in B-frame will not be propagated to other frames and allowing bigger error in B-frame is more common than in P-frame or I-frame. Encoding of the three MPEG pictures becomes tradeoff among performance, bit rate and image quality, the resulting ranking of the three factors of the three types of picture encoding are shown as below:

| | Performance | | |
|---|---|---|---|
| | (Encoding speed) | Bit rate | Image quality |
| I-frame | Fastest | Highest | Best |
| P-frame | Middle | Middle | Middle |
| B-frame | Slowest | Lowest | Worst |

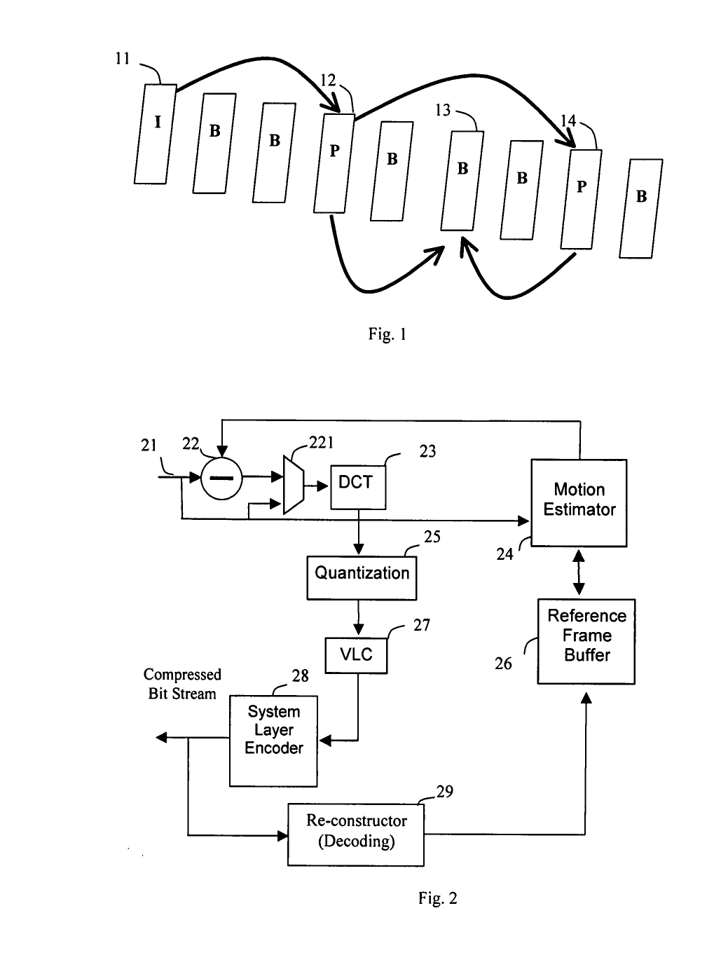

FIG. 2 shows the block diagram of the MPEG video compression procedure, which is most commonly adopted by video compression IC and system suppliers. In I-type frame coding, the MUX 221 selects the coming original pixels 21 to directly go to the DCT 23 block, the Discrete Cosine Transform before the Quantization 25 step. The quantized DCT coefficients are packed as pairs of “Run-Length” code, which has patterns that will later be counted and be assigned code with variable length by the VLC encoder 27. The Variable Length Coding depends on the pattern occurrence. The compressed I-type frame or P-type bit stream will then be reconstructed by the reverse route of decompression procedure 29 and be stored in a reference frame buffer 26 as future frames' reference. In the case of compressing a P-frame, B-frame or a P-type, or a B-type macro block, the macro block pixels are sent to the motion estimator 24 to compare with pixels within macroblock of previous frame for the searching of the best match macroblock. The Predictor 22 calculates the pixel differences between the targeted 8×8 block and the block within the best match macroblock of previous frame or next frame. The block difference is then fed into the DCT 23, quantization 25, and VLC 27 coding, which is the same procedure like the I-frame coding.

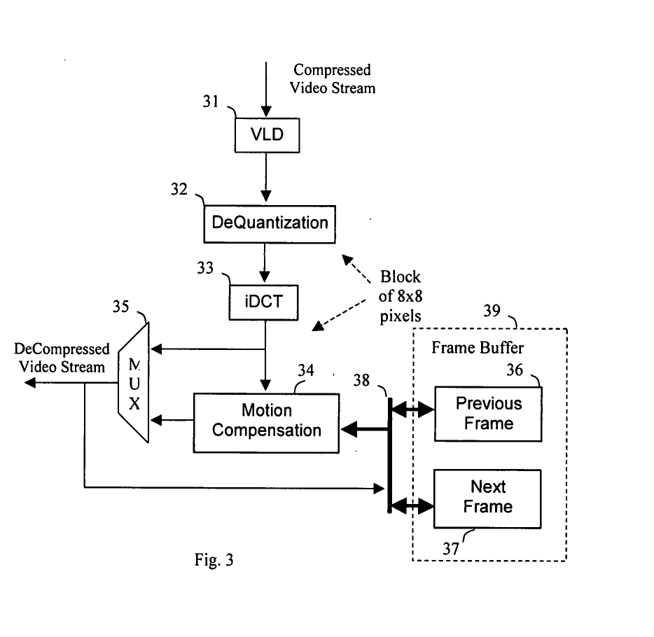

FIG. 3 illustrates the basic procedure of MPEG video decompression. The compressed video stream with system header having many system level information including resolution, frame rate, . . . etc. is decoded by the system decoder and sent to the VLD 31, the variable length decoder. The decoded block of DCT coefficients is shifted by the “Dequantization” 32 before they go through the iDCT 33, inverse DCT, and recovers time domain pixel information. In decoding the non intra-frame, including P-type and B-type frames, the output of the iDCT are the pixel difference between the current frame and the referencing frame and should go through motion compensation 34 to recover to be the original pixels. The decoded I-frame or P-frame can be temporarily saved in the frame buffer 39 comprising the previous frame 36 and the next frame 37 to be reference of the next P-type or B-type frame. When decompressing the next P-type frame or next B-type frame, the memory controller will access the frame buffer and transfer some blocks of pixels of previous frame and/or next frame to the current frame for motion compensation. Storing the referencing frame buffer on-chip costs high semiconductor die area and very costly. Transferring block pixels to and from the frame buffer consumes a lot of time and I/O 38 bandwidth of the memory or other storage device. To reduce the required density of the temporary storage device and to speed up the accessing time in both video compression and decompression, compressing the referencing frame image is an efficient new option.

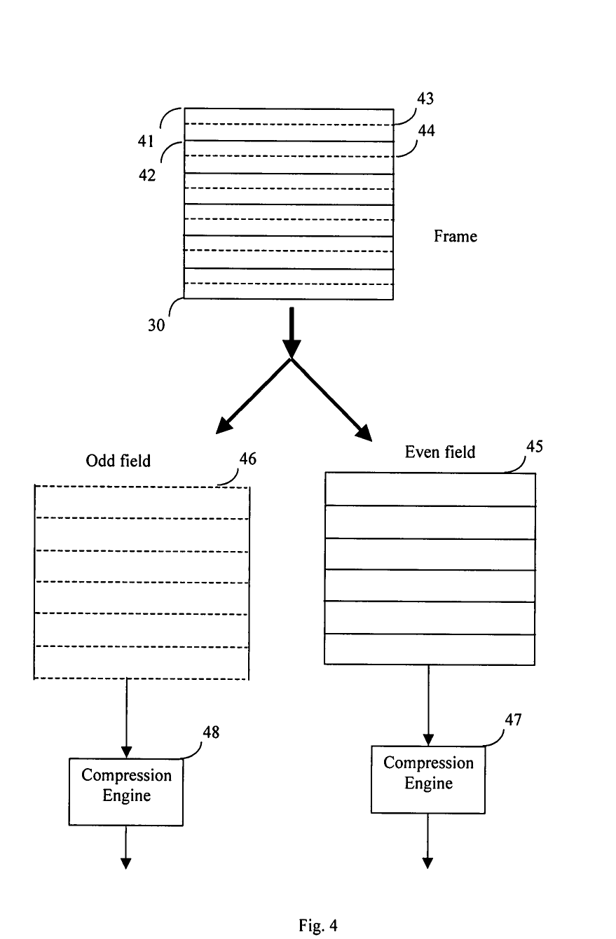

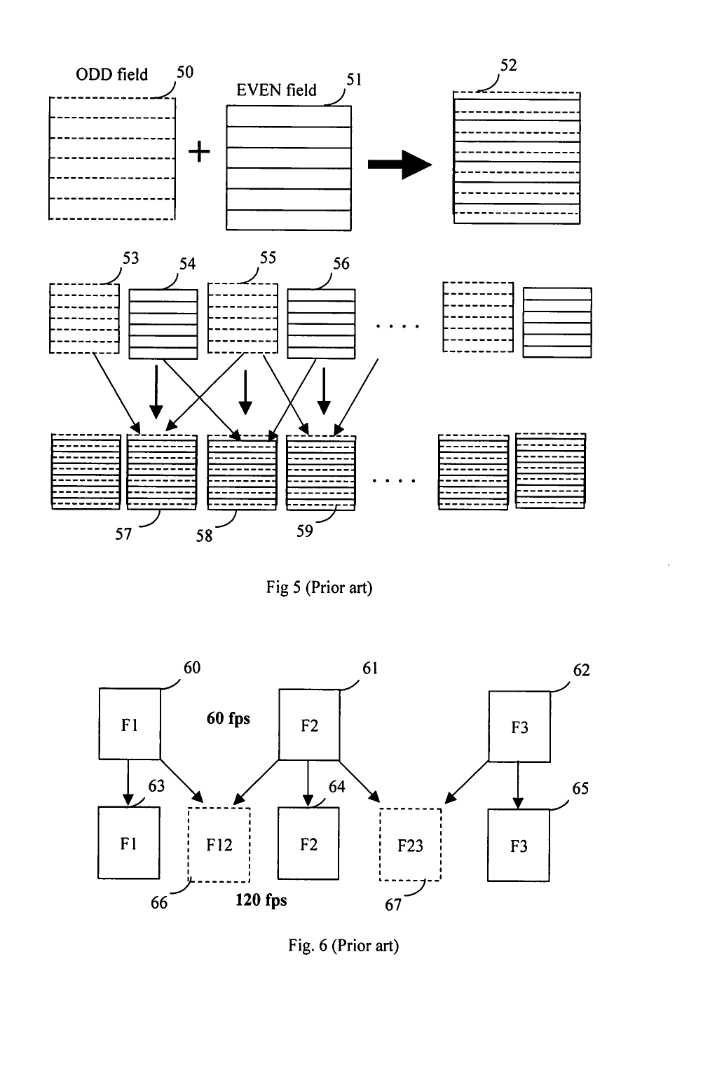

In some video applications like TV set, since the display frequency is higher than 60 frames per second (60 fps), most likely, interlacing mode is adopted, in which, as shown in FIG. 4, even lines 41, 42 and odd lines 43, 44 of pixels within a captured video frame will be separated and form “Eve field 45” and “Odd field 46” and compress them separately 48, 49 with different quantization parameters which causes loss and error and since the quantization is done independently, after decompression, when merging them to be a “frame” again, the individual loss of different field causes obvious artifacts in some area like edge of an object. In some applications including TV set as shown in FIG. 5, the interlaced images with odd field 50 and even field 51 will be re-combined to form “Frame” 52 again before displaying. The odd lines of even field position 57, 59 will be filled most likely by compensation means of adjacent odd fields 53, 55 . . . To minimize the artifact caused by video compression of interlacing mode, de-interlacing might apply not only adjacent previous and next fields, but also between 3 to 4 previous fields and 3-4 next fields for compensation and to reconstruct the odd or even lines of pixels. It is obvious that de-interlacing requires reading multiple previous and next files of pixels which cost high memory IO bandwidth. Normally, a pixel will be read from the off-chip memory for 4-8 times for video de-interlacing and being written back once after de-interlacing is done.

Another procedure consuming a lot memory IO bandwidth is the frame rate conversion which interpolates and forms new frame between decoded frames. For a video with 30 frames per second or said 30 fps converting to 60 fps, or from a 60 fps converting to 120 fps, the easiest way is to repeat very frame which can not gain good image quality. As shown in FIG. 6, one can also easily interpolates and forms a new frame 66, 67 between every two existing adjacent frames 60, 61, 62 which requires reading each pixel at least twice. For gaining even better image quality, multiple previous frame and multiple future frames are read to compensate and interpolate to form the new frame which consumes high memory IO bandwidth. In prior solution in De-Interlacing and frame rate conversion is they are done separately and require accessing the frame buffer memory for 6-8 times individually.

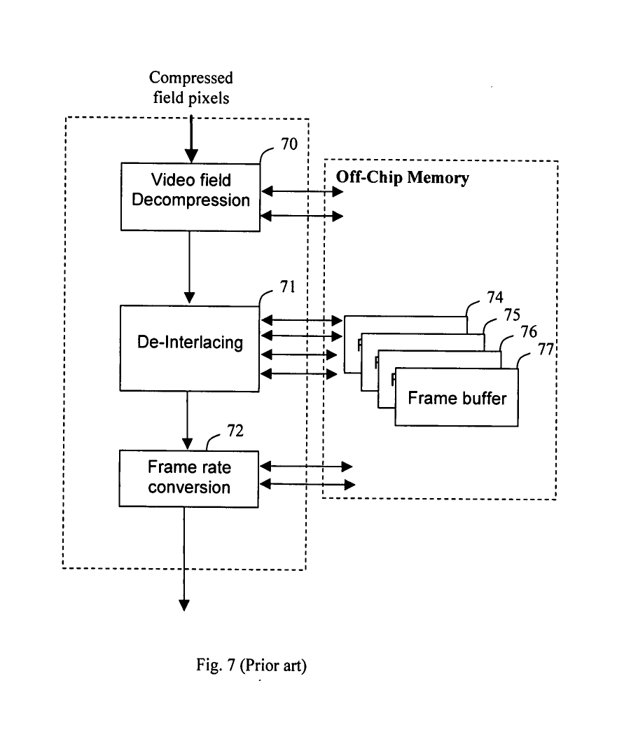

FIG. 7 depicts an example of the conventional means of the video decompression 70, de-interlacing 71 and frame rate conversion 72. Each of the three procedure requires high image data traffic in reading and writing pixels from and to the frame buffers. Due to the heavy traffic on memory bus, and since commodity memory has limited data width like SDRAM, DDR or DDR2 they have most likely 8 bits or at most 16 bits wide are the main stream which costs less compared to 32 bits wide memory chips. Applying some multiple memory chips 74, 75, 76, 77 becomes common solution to provide the required IO bandwidth which is costly and results in difficulty in system board design and much EMI, Electro-Magnetic Interference problems can be introduced.

The present invention provides method of reducing the required memory bandwidth by buffering and re-compressing the decompressed lines of video image and applying these lines of pixels for as de-interlacing and interpolating to form the needed new frame of pixels and these two function of de-interlacing and frame rate conversion (or frame interpolation) are done by referring to those pixels temporarily stored in the line buffers. Therefore it avoids the need of multiple accessing the same referencing frame buffer. Should the application applies off-chip memory as frame buffer, the re-compressed frames are stored in the frame buffer with compressed format and read back when timing matched for de-interlacing and frame rate conversion.

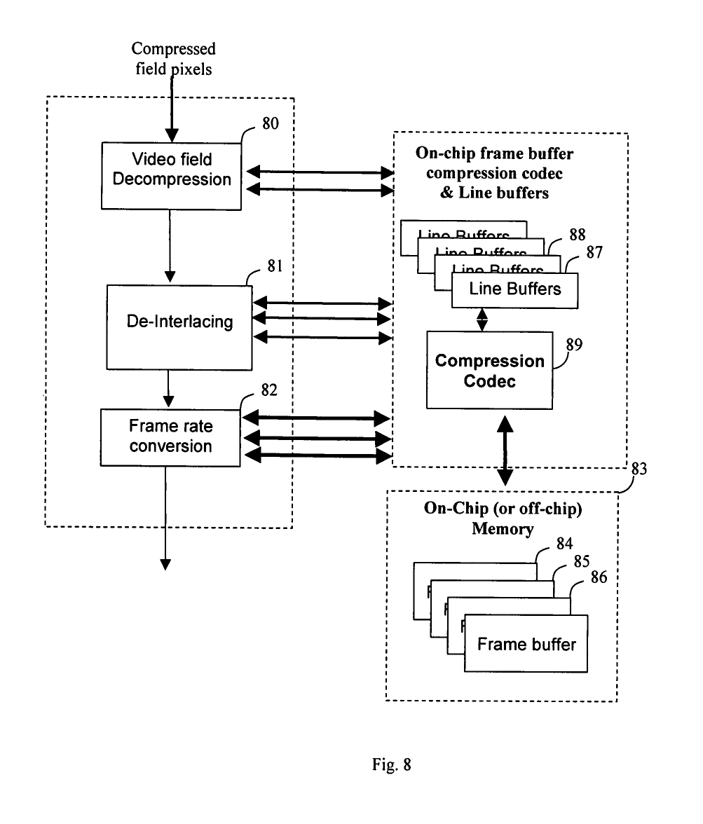

As shown in FIG. 8, the image fields or frames decompressed from the video decompression engine 80 are re-compressed by the compression engine 89 before storing to the image buffer 83 which might be comprised of multiple frames 84, 85, 86 . . . And these compressed images can be read back and temporarily saved in another temporary image buffer 87, 88. When timing matched, the image decompression engine 89 reconstructs the lines of pixels for video de-interlacing 81 and frame rate conversion 82 since it is done in line by line sequence, it is easy to control the timing and recover the needed lines of pixels. By compressing the image buffer information, one can easily reduce the required IO bandwidth of the frame buffer memory. In some applications, multiple video decompression engines are applied to decompress at least two video fields/frames at a time, and the reconstructed rows of pixels can be re-compressed again and saved in a temporary image buffer 87, 88 for de-interlacing and frame rate conversion before writing to the image buffer, when timing matched, the compressed image stored in the temporary line buffer can be decompressed and used for de-interlacing and frame rate conversion to form complete and new video frames. Variable bit rate each line is adopted in this invention with a short code representing the starting address in memory or representing the variance of code length. By 1-2 clock cycle, the starting address of each line can be recovered and the starting pixel of leach line can be accessed.

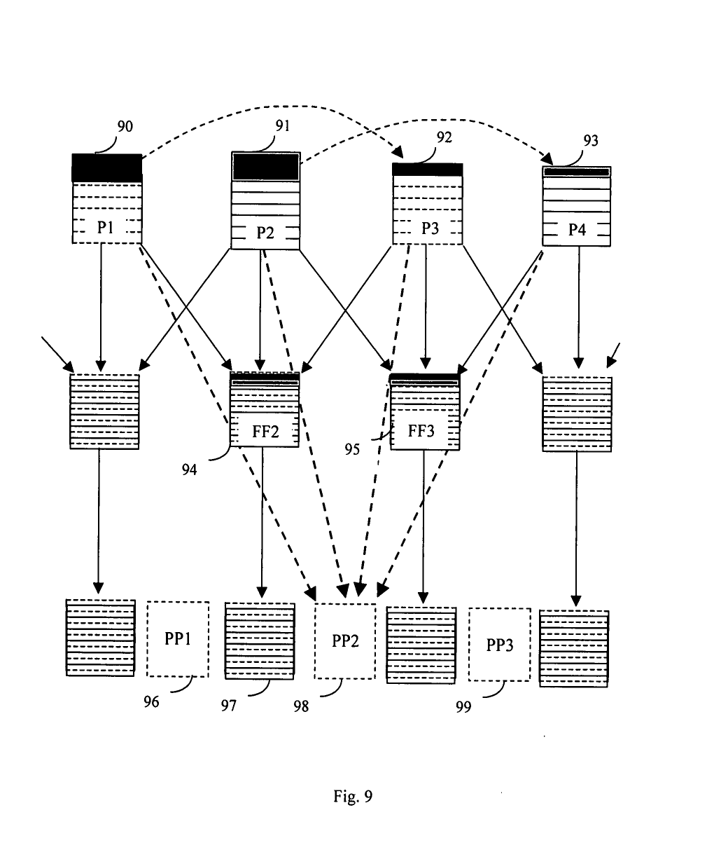

FIG. 9 illustrates just an example of this invention of video decompression, de-interlacing and frame rate conversion directly from the reconstructed rows of pixels. If the input video stream is a compressed video format, multiple video frame decoding engines are applied to decompressing the video frames and the reconstructed rows of pixels in each video filed/frame are re-compressed row by row and become the reference of the future field/frame as like P3, 92 refers to P1, 90 and P4, 93 refers to P2, 91. In most video compression standards, motion compensation is done in macro-block based which means, once the targeted frame has reconstructed more than 32 lines of pixels, these temporarily stored on-chip said 32 lines pixels can be used to start decompressing the next frame/field pixels in parallel since the macro-block pixels are supposed to be compressed and also decompressed sequentially from left top to right bottom. Therefore, applying at least two video decoding engines and let them decompress 2 frame/field simultaneously, the reconstructed lines of fours fields/frames P1, P2, P3, P4, 90, 91, 92, 93 which are compressed and temporarily stored in the on-chip line buffer can be decompressed and start de-interlacing two frames FF2, FF3, 94, 95 and these four fields/frames can interpolate and form new frame PP2, 98. When time goes on, the following future two frames/fields P5, 6 together with P3, P4 can de-interlacing two frames FF4, FF5 and interpolate to form new frame PP3, 99. Compressing the decoded video field/frame helps saving the on-chip line buffer die area/cost.

FIG. 9 is just only an example using only two frames/fields for de-interlacing or fours fields/frames for frame rate conversion to illustrate the concept of this invention of video decoding, de-interlacing and frame rate conversion done in the same time. Row by row re-compressing the decoded video field/frame helps saving the on-chip line buffer die area/cost. Applying this invention, the decompressed rows of macro-block video frame of pixels stored in the on-chip line buffer can be referred for future field/frame decompression and de-interlacing as well as frame rate conversion before written to the frame buffer or other storage device and can avoid multiple accessing for de-interlacing and later for frame rate conversion.

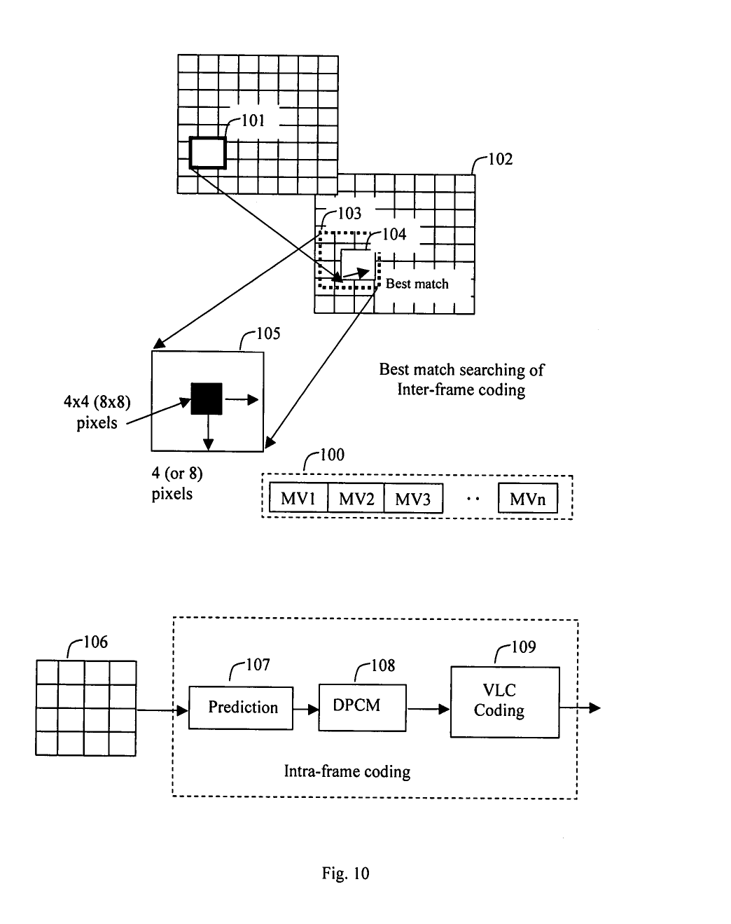

FIG. 10 depicts two modes of the image frame buffer compression mechanisms, an “Inter-frame” coding and an “Intra-frame” coding. In inter-frame mode, the different between adjacent frames is calculated and coded by a VLC coding means. A best matching block 104 with the position within a predetermined rang 103 of the “Next frame” 102 is identified first, and the differential values between the targeted block 101 and the best matching block are calculated and are coded by a VLC coding means. For saving the computing times, a limited searching range 105 is defined in this invention to quickly decide the best matching block or if the least MAD value is larger than a predetermined threshold, it stops motion estimation and give up inter-frame coding, instead, the targeted block of pixels will be coded by an intra-frame coding means.

For saving computing times, the code of “Motion Vectors (MV)” in the compressed video stream will be saved into a temporary buffer 100 which can be used for re-compressing for the motion estimation in inter-frame coding. And since this invention might have shorter searching range compared to other video compression standards, for instance, this invention limits searching range to be +/−8 pixels, most video standard have +/−16 or +/−32 pixels. Should the MV is out of the limited searching range, said +/−8 pixels, an intra-frame coding is enforced. An intra-frame coding of this invention is comprised of three procedures, a block of pixels 106 are input to an prediction unit 107 to estimated the differential value between each pixel and the corresponding predictive value which is called DPCM 108 (Differential Pulse Coded Modulation). The differential values of a block will be then be coded by a VLC coding means 109. In this invention, both inter-frame and intra-frame coding means will be applied to compression each block of pixels, which results in less bit rate will be selected to be the output of compressed data. Both inter-frame and intra-frame coding means compress the block pixels with variable bit rate and come out of a fixed bit rate of each “Row” of block for quick accessing.

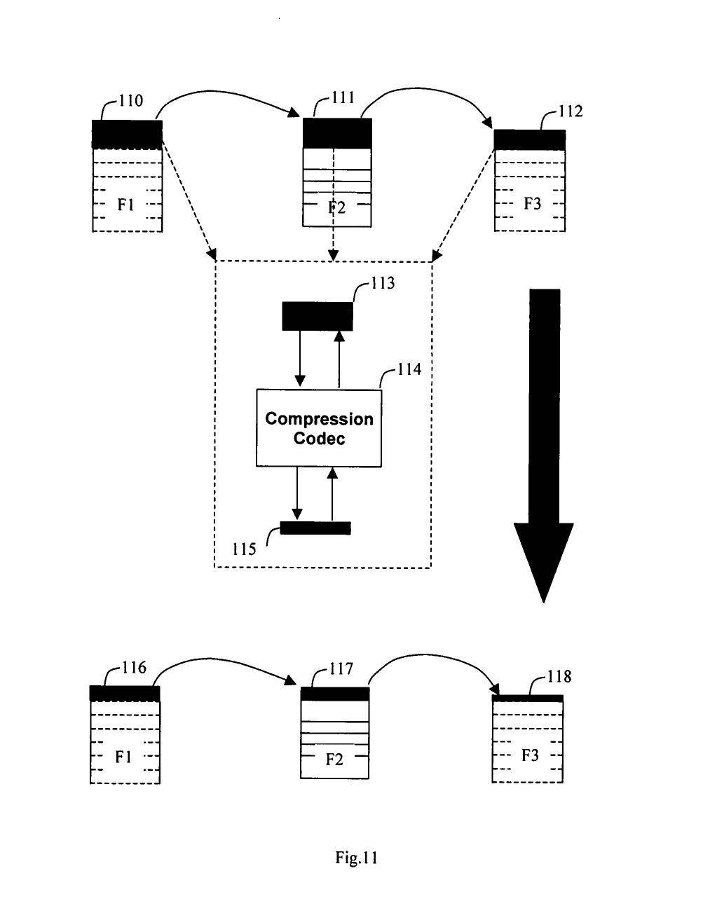

The video frames under decompression with rows of macro-blocks of pixels can be directly applied to de-interlacing and frame rate conversion as shown in FIG. 11. For saving the on-chip pixel buffer, the decompressed rows 110, 111, 112 of macro-block of pixels of each frame is re-compressed to reduce the bit rate. These sequential rows of macro-blocks are referred by next frame/field. When timing matched, a decompression unit will reconstruct the corresponding row of macro-block of pixels and saves to a line buffer for de-interlacing and frame rate conversion. With this compression codec 114, a row of reconstructed pixels 113 can be compressed and reduced to be smaller size 115. And the compressed row of pixels will be decompressed for other field/frame decompression. By using this re-compression codec, the required density/size 116, 117, 118 of rows of macro-block pixels can be reduced.

The temporary buffer used to store the decompressed image and the re-compressed image is overwritten with newly decompressed pixels after a predetermined row of block pixels of the future field/frame are compressed.

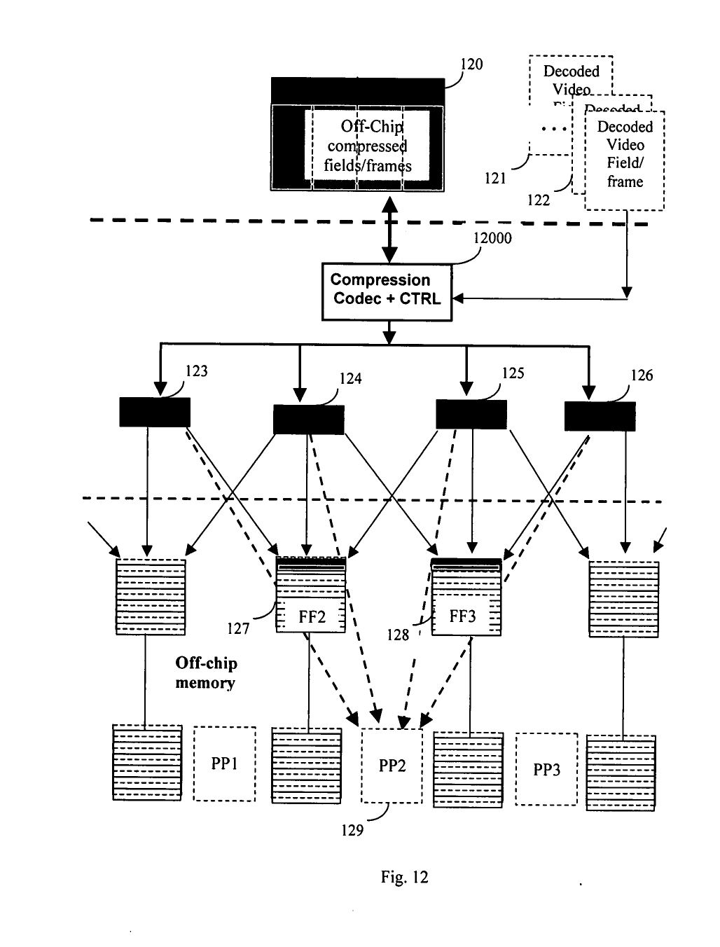

If the source of video is an uncompressed or a decompressed video frames 121, 122, (or said from a DVD player) as shown in FIG. 12, the sequentially received image fields/frames will be compressed 1200 before storing into an off-chip memory 120. When the timing matched, the compressed video fields/frames will be read and decompressed line by line and saved into the line buffer 123, 124, 125, 126 for future de-interlacing new frames FF2, FF3, 127, 128 and frame rate conversion of constructing new frame, PP2, 129 between adjacent fields or frames. Therefore, applying the present invention for de-interlacing and frame conversion will require only reading the compressed fields/frames only once with each field/frame pixel data compressed which sharply reduces the requirement of memory IO bandwidth.

In digital TV broadcasting, the video programs are compressed video and is received and saved into another temporary buffer. A video parser can screen and separately sends the compressed field/frame to the corresponding video decoding engine. In another traditional TV mode or DVD player, the TV system receives the video fields/frames in the decompressed format which costs higher data rate each field/frame. In this invention, if the received video field/frame is decompressed form, then, the similar compression mechanism is applied to reduce the data rate and saved the re-compressed frames into either an on-chip or an off-chip frame buffer memory. If the re-compressed frames are stored in the off-chip frame buffer memory, reading back multiple rows of block pixels of at least two fields/frames are very likely and decompress them and save into the line buffer for future de-interlacing and frame rate conversion.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of manipulating the input compressed video data, digital video decompression, de-interlacing and frame rate conversion, comprising:
Storing the input compressed video stream into the first temporary buffer, parsing the video stream and sending the corresponding compressed video data into corresponding decompression engine;
decompressing at least two video fields or frames and re-compressing the reconstructed pixels, then saving them to the corresponding on-chip first line buffer;
reconstructing at least two lines of pixels from each referencing field/frame stored in the on-chip first line buffer and saving into a on-chip second line buffer;
de-interlacing and constructing the frame image by referring to the reconstructed lines of pixels of the corresponding referencing field/frame which are temporarily stored in the on-chip second line buffer; and
constructing new frame between the decompressed fields/frames by referring to the reconstructed lines of pixels of the corresponding referencing field/frame which are temporarily stored in the on-chip second line buffer.

2. The apparatus of claim 1, wherein the input compressed video field/frame are in a form of macron-block, comprising Y, luminance components, U chrominance components and V chrominance components.

3. The apparatus of claim 1, wherein re-compressed row pixels of at least two referencing fields/frames are decompressed and temporarily stored in a line pixel buffer for future de-interlacing and frame rate conversion.

4. The apparatus of claim 1, wherein the decompression engine used to reconstruct the line pixels will decompress pixel components of each referencing field/frame separately until the end of field/frame.

5. The apparatus of claim 1, wherein the rows of block pixels of the re-compressed referencing field/frame are used for the re-compression of future field/frame.

6. The apparatus of claim 1, wherein during de-interlacing, at least two lines in each of at least two adjacent fields/frames are referred in deciding the motion compensation of each pixel.

7. The apparatus of claim 1, wherein during frame rate conversion, at least two lines in each of at least two adjacent fields/frames are referred in deciding the motion compensation of each pixel.

8. A method of re-compressing the decompressed video filed/frame for future de-interlacing and frame rate conversion, comprising:
decompressing at least two macro-bloc pixels of the referencing video field/frame and saving the motion vectors, MVs of each macro-block into a temporary MV buffer;
Re-compressing the decompressed referencing frame block by block with an inter-frame coding means comprising the calculation of differential values of pixels between the targeted block of current field/frame and the best matching block of previous field/frame with the corresponding MVs copied from the temporary MV buffer if the MV, if the corresponding MV is out of the predetermined threshold, then, skipping inter-frame coding;
Re-compressing the decompressed referencing frame block by block with an intra-frame coding means comprising the calculation of block differential values of adjacent pixels and a VLC coding means to represent the differential values; and
Selecting one of results of the two re-compression mechanism to be the output of re-compression and saving it to the referencing frame buffer memory for future calculation of video decompression, de-interlacing and frame rate conversion.

9. The method of claim 8, wherein a predetermined size of line buffer temporarily saving the row of macro-block pixels of reference frame and the decompressed row of macro-block pixels is dependent on the resolution of video frame, the larger the resolution, the larger the macro-block size and more longer line will be implemented.

10. The method of claim 8, wherein a whole row of block pixels of the reference field/frame and the decompressed row of macro-block pixels is overwritten with newly reconstructed row of macro-block pixels when the row of block pixels have already referred by future field/frame and the decompression of the corresponding row of macro-block of future field/frame are completed.

11. The method of claim 8, wherein the temporary buffer used to store the MVs of macro-blocks of the decompressed video field/frame has capacitance of saving at least one row of macro-blocks for inter-frame coding in re-compression.

12. The method of claim 8, wherein a predetermined threshold is always compared to the corresponding MV of the targeted block, should the MV is more than the threshold, inter-frame coding mechanism will be skipped and the intra-frame coding will be selected to be the only coding means.

13. The method of claim 8, wherein if the MV of the corresponding block is within the corresponding threshold, the differential values of the best matching block pixels of the future field/frame and the targeted block will be re-calculated and be coded by a VLC coding means.

14. The method of claim 8, wherein the compressed bit rate of block pixels varies from block to block with each row of blocks having a predetermined data rate.

15. A method of manipulating the input uncompressed or decompressed video field/frame data, and further de-interlacing and frame rate conversion, comprising:
compressing at least two received video fields or frames and saving them to the off-chip field/frame buffer memory;
in a predetermined timing, accessing the compressed pixels from the corresponding off-chip referencing field/frame memory, decompressing the accessed compressed pixels and storing the reconstructed pixel into the on-chip line buffer;
de-interlacing and constructing the frame image by referring to the reconstructed line pixels of at least two referencing fields/frames; and
constructing new frame between the decompressed fields/frames by referring to the reconstructed line pixels of at least two referencing fields/frames.

16. The method of claim 15, wherein the on-chip line buffer can store at least two compressed lines of Y, U and V pixel components of at least two referencing video field/frame for de-interlacing and frame rate conversion.

17. The method of claim 15, wherein reconstructed lines of pixels of the referencing field/frame which no longer needed for de-interlacing or frame rate conversion and the lines of the reconstructed de-interlacing frame and converted new frame are written to the off-chip frame buffer for display.

18. The method of claim 15, wherein the on-chip line buffer of top line of at least one video fields/frames is overwritten with newly accessed and decompressed line pixels of the future field/frame.
